(19) United States
(12) Patent Application Publication
(10) Pub. No.: US 2019/0044788 A1
(43) Pub. Date: Feb. 7, 2019

(54) USING A MOBILE DEVICE TO INITIATE MANAGEMENT OF A SERVER

(71) Applicant: Lenovo Enterprise Solutions (Singapore) Pte. Ltd., Singapore (SG)

(72) Inventors: Matthew R. Alcorn, Durham, NC (US); James G. McLean, Raleigh, NC (US); Christopher A. Peterson, Richfield, MN (US); Antonio Abbondanzio, Raleigh, NC (US); Randall W. Worzella, Raleigh, NC (US)

(21) Appl. No.: 15/670,880

(22) Filed: Aug. 7, 2017

(51) Int. Cl. H04L 12/24; G06F 13/42

(52) U.S. Cl. CPC H04L 41/048; G06F 13/4282; G06F 8/60; H04L 41/0803; H04L 41/28

(57) ABSTRACT

A computer server includes a baseboard management controller having a serial bus controller. The computer server further includes a serial bus port disposed along a front panel of a server enclosure of the computer server. A serial bus couples the serial bus port to the serial bus controller. Accordingly, an application running on a mobile computing device may establish communication with the baseboard management controller via a serial communication cable physically connected between the mobile computing device and the front panel serial bus port of the server. The mobile computing device may send a management instruction to the baseboard management controller over the serial communication cable and the serial bus, and the baseboard management controller may forward the management instruction over a network connection to a management computer.

### BACKGROUND

The present disclosure relates to the provisioning and management of servers.

### BACKGROUND OF THE RELATED ART

In a systems management environment, management of datacenter hardware by a management computer is a common and repetitive task. In order to managing the datacenter hardware, such as a large number of servers, the user uses a laptop or other remote console to access the interface to the management computer. For example, a datacenter may have a substantial number of servers, where each server has a baseboard management controller (BMC) that can communicate with the management computer over a network. From the centralized management interface, the user can manage each of the servers.

### BRIEF SUMMARY

One embodiment provides an apparatus comprising a computer server including a baseboard management controller, wherein the baseboard management controller has a serial bus controller. The apparatus further comprises a serial bus port disposed along a front panel of a server enclosure that houses the computer server, wherein the serial bus port is accessible for connection with a connector of a serial communication cable. Still further, the apparatus comprises a serial bus that couples the serial bus port to the serial bus controller.

Another embodiment provides a method comprising establishing communication between an application running on a mobile computing device and a baseboard management controller of a server, wherein the application communicates with the baseboard management controller over a serial communication cable physically connected between the mobile computing device and a serial bus port in a front panel of the server, and wherein the serial bus port is coupled to a serial bus controller of the baseboard management controller via a serial bus. The method further comprises the mobile computing device sending a management instruction to the baseboard management controller over the serial communication cable and the serial bus, and the baseboard management controller forwarding the management instruction over a network connection to a management computer.

### BRIEF DESCRIPTION OF THE SEVERAL VIEWS OF THE DRAWINGS

FIG. 1 is a diagram of a system including a server that is managed by a management computer and has a serial bus port on the front panel of the server for being connected to a cable from a mobile computing device.

FIG. 2 is a diagram of a server according to one embodiment.

FIG. 3 is a diagram of a computer that is representative of a management computer.

FIG. 4 is a diagram of a mobile computing device in the form of a smartphone.

FIG. 5 is a flowchart of a method according to another embodiment.

### DETAILED DESCRIPTION

One embodiment provides an apparatus comprising a computer server including a baseboard management controller, wherein the baseboard management controller has a serial bus controller. The apparatus further comprises a serial bus port disposed along a front panel of a server enclosure that houses the computer server, wherein the serial bus port is accessible for connection with a connector of a serial communication cable. Still further, the apparatus comprises a serial bus that couples the serial bus port to the serial bus controller. In one example, the serial bus port may be a Universal Serial Bus (USB) port. In certain embodiments, a management computer may be in communication with the baseboard management controller over a management network.

Another embodiment provides a method comprising establishing communication between an application running on a mobile computing device and a baseboard management controller of a server, wherein the application communicates with the baseboard management controller over a serial communication cable physically connected between the mobile computing device and a serial bus port in a front panel of the server, and wherein the serial bus port is coupled to a serial bus controller of the baseboard management controller via a serial bus. The method further comprises the mobile computing device sending a management instruction to the baseboard management controller over the serial communication cable and the serial bus, and the baseboard management controller forwarding the management instruction over a network connection to a management computer.

The mobile computing device may, for example, be a smart phone, tablet computer and notebook computer. The mobile computing device preferably includes a serial bus port, such that a first connector of a serial communication cable is coupled to the serial bus port of the mobile computing device and a second connector of the serial communication cable is coupled to a serial bus port of a server that a user selects to manage. Accordingly, a user may manage the selected server from a location directly in front of the selected server, rather than being required to sit in front of a management computer that may be some distance away. Furthermore, the user may move from one server to another as desired and manage any selected server by coupling the serial communication cable to the serial bus port on the front panel of the selected server.

In one option, the application running on the mobile computing device provides a management interface enabling the user to take various management actions relative to the server to which the mobile computing device is presently connected. In another option, the application running on the mobile computing device receives input of user credentials from a user, and then passes the user credentials to the management computer to authenticate the user of the application. In yet another option, the application running on the mobile computing device obtains and displays management data associated with the server, wherein the application displays the management data on a display component of the mobile computing device. Any of these options may be implemented alone or in combination with any other of these options. The application may be, without limitation, the Lenovo XClarity Mobile application. Independently, the management computer may be, without limitation, a Lenovo XClarity Administrator.

In a further option, the application may pass information to the server, wherein the information is selected from the group consisting of the location of a rack in which the server is located, the position of the server within the rack, the name of the server, and an Internet Protocol (IP) address for the server. Accordingly, the application provides the server with information identifying the server that the server may not otherwise have available. This information may be useful for many purposes in managing the server. In one example, the server may provide the identifying information to the management computer, such that the management computer may use the information to generate a virtual rack layout.

After the mobile computing device has sent a management instruction to the baseboard management controller, and after the baseboard management controller has forwarded the management instruction to the management computer, the management computer may perform a management task for the server in response to receiving the management instruction. For example, the management instruction may indicate or identify the management task that should be performed. One exemplary management instruction is a provisioning instruction identifying software to be downloaded from the management computer to the server. Another exemplary management instruction is a provisioning instruction identifying a server profile, wherein the management task includes configuring the server according to a predetermined server configuration that is associated with the identified server profile.

The management computer may perform the management task for the server while the mobile computing device is still connected to the serial bus port of the server or after the mobile computing device has been disconnected from the serial bus port of the server. Still further, it is possible for the application may communicate with the server regardless of whether the server is already under management or not yet under management. In one option, the server may send a request for the management computer to initiate performance of the management task for the server, wherein the management computer performs the management task for the server in response to receiving the request. Accordingly, the server may identify a good opportunity for the management task, such as when the server is not under any heavy workload. In another option, the management computer may periodically poll the server for a pending management instruction, wherein the server sends the management instruction to the management computer in response to being polled by the management computer. For example, the server may respond to being polled by sending an additional tag in its service location protocol (SLP) response, where the additional tag identifies the management instruction. In this latter option, the management computer may poll the server at a time that the management computer has available capacity or bandwidth to perform a management task for the server. Since the management computer will typically manage a large number of servers, the management computer may sequentially poll the servers as capacity or bandwidth becomes available for performing additional management tasks.

Embodiments may include computer program products comprising non-transitory computer readable storage media having program instructions embodied therewith, wherein the program instructions are executable by a processor to implement or initiate any one or more aspects of the methods described herein. Accordingly, a separate description of the methods will not be duplicated in the context of a computer program product. It should be recognized that any computer program product may be distributed among the mobile computing device, a selected server, and the management computer, such that each entity performs its own contribution to the disclosed methods.

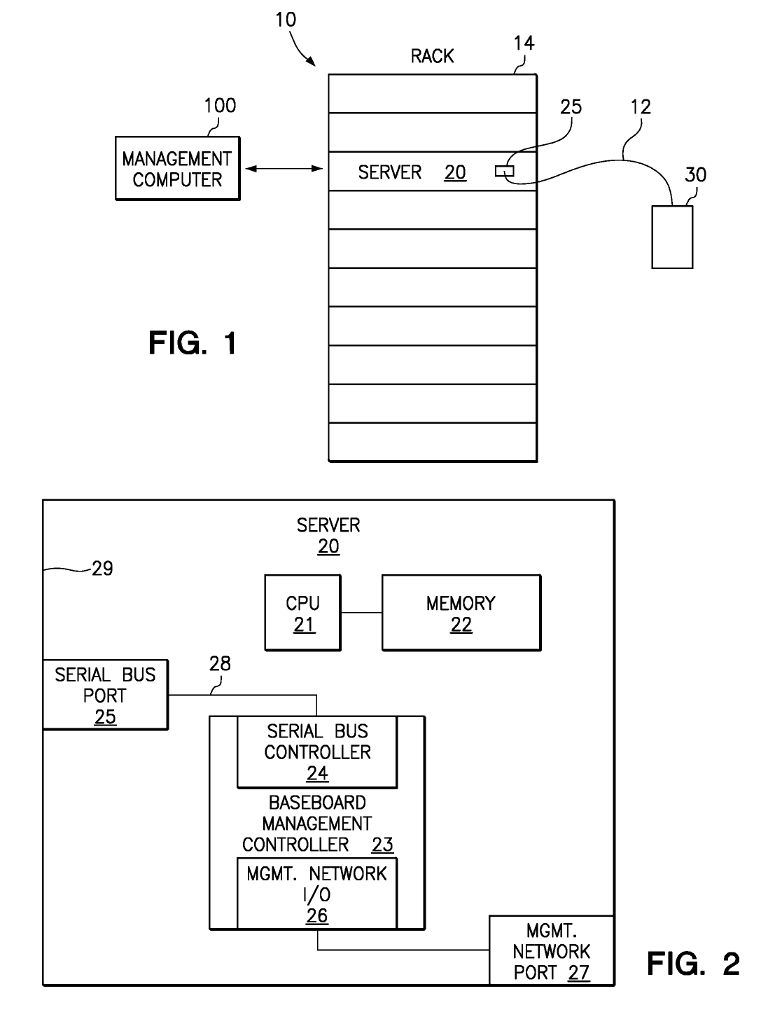

FIG. 1 is a diagram of a system 10 including a server 20 that is managed by a management computer 100 and has a serial bus port 25 on the front panel of the server for being connected to a cable 12 from a mobile computing device 30. The server 20 may be among any number of servers stored in one or more racks 14. For example, a datacenter may have a large number of racks 14, with each rack supporting multiple servers like the server 20. An individual user, such as a system administrator, may select any one of the servers 20 in any one of the racks 14 and then communicate with, and manage, the selected server 20 using the mobile computing device 30 by first connecting the cable 12 between the mobile computing device 30 and the serial bus port 25 on the front panel of the selected server.

The individual user may use the mobile computing device 30 to be authenticated to the management computer 100 before or after being connected to the server 20. However, after the mobile device is connected to the server, the individual user may also use the mobile device to be authenticated to the server 20 and then request a management action on the server. The server 20 may subsequently communicate the credentials of a user or mobile computing device and the requested management action to the management computer 100 such that the management computer will implement the requested management action on the server if the credentials are approved. In one option, the credentials are approved in response to the credentials being both valid and sufficient. Credentials may be valid if they are recognized as those a registered user, and credentials may be sufficient if the privileges or authorization level associated with the registered user are adequate to authorize the requested management action.

An application running on the mobile computing device 30 may recognize both the management computer 10 and the server 20, perhaps identifying the management computer and each server by a unique network identifier. Furthermore, the application may accept entry of credentials, such as a username and password, which authenticate the user/device to the management computer, and may similarly accept entry of credentials, such as a username and password, which authenticate the user/device to the server. Accordingly, the mobile computing device running the application may be able to communicate with both the management computer and the connected server. Optionally, the application may store the credentials for any one or more of the management computer and plurality of servers.

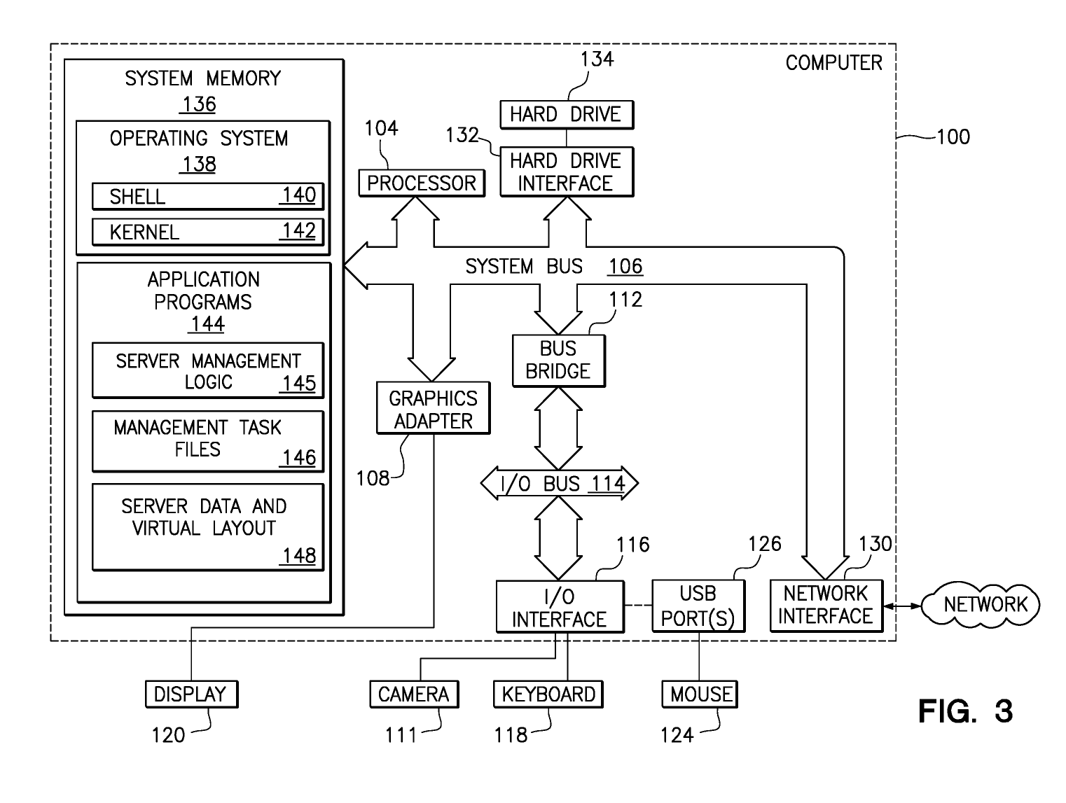

FIG. 2 is a diagram of a server 20 according to one embodiment. Many of the details of a server are omitted, but an example of suitable architecture for the server may be found by reference to the computer 100 shown in FIG. 3. The server 20 includes a central processing unit (CPU) 21 and memory 22 for performing various in-band workloads. However, the server 20 also includes a baseboard management controller 23, which is a service processor that monitors and manages various aspects of the server 20. The use of the term “baseboard management controller” is used broadly and is intended to include any service processor, such as a “unified extensible firmware interface”, that performs the function of the baseboard management controller 23 even if it may also perform other functions.

The baseboard management controller 23 includes both a serial bus controller 24, such as a universal serial bus (USB) controller, and a management network input/output adapter 26, such as an Ethernet adapter. The serial bus controller 24 is coupled to a serial bus port 25 via a serial bus 28. As shown, the serial bus port 25 is disposed along a front face 29 of the server 20 and is open in the forward direction such that a connector on a serial communication cable (see cable 12 in FIG. 1) may be plugged into the serial bus port 25 from the front of the server. The management network input/output adapter 26 is coupled to a management network port 27, such as an Ethernet port, that that is open for connection with a network cable to the management computer 100 (see FIG. 1).

An individual user may interact with the baseboard management controller 23 by connecting a mobile computing device 30 (see FIG. 1) to the serial bus port 25 via a cable. Management instructions may be passed from the mobile computing device to the baseboard management controller 23 and subsequently passed to the management computer 100 via the management network port 27.

FIG. 3 is a diagram of a computer that is representative of the management computer 100 of FIG. 1 according to one embodiment. Furthermore, the architecture of the computer may also be representative of the server 20 of FIG. 1, yet not showing the baseboard management controller 23, serial bus port 25, and management network port 27 of FIG. 2.

The computer 100 includes a processor unit 104 that is coupled to a system bus 106. The processor unit 104 may utilize one or more processors, each of which has one or more processor cores. A graphics adapter 108, which drives/supports a display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, including a camera 111, a keyboard 118, and a USB mouse 124 (or other type of pointing device) via USB port(s) 126. As depicted, the computer 100 is able to communicate with other network devices over a network using a network adapter or network interface controller 130. Where the computer 100 is a management computer, the network may be a management network for managing any number of servers via communication with the baseboard management controllers on those servers.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 100. This volatile memory includes additional higher levels of volatile memory (not shown), including, but not limited to, cache memory, registers and buffers. Data that populates the system memory 136 includes the operating system (OS) 138 and application programs 144.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 may be a text-based, line-oriented user interface, the present invention may support other user interface modes, such as graphical, voice, gestural, etc.

As depicted, the operating system 138 also includes the kernel 142, which includes lower levels of functionality for the operating system 138, including providing essential services required by other parts of the operating system 138 and application programs 144. Such essential services may include memory management, process and task management, disk management, and mouse and keyboard management.

As shown, the computer 100 includes application programs 144 in the system memory of the computer 100, including, without limitation, server management logic 145, management task files 146 and server data and virtual layout data 148 in order to implement one or more of the embodiments disclosed herein. For example, the server management logic 145 may receive management data and management instructions from the various servers and may send configuration setting and files to the various servers. The management task files 146 may include applications, firmware and control settings for various management tasks that need to be performed for a particular server. The server data and virtual layout data 148 may include identifying information about each server, such as a server name, server location (rack and position within the rack), and network address, to facilitate communication and management of each server.

The hardware elements depicted in the computer 100 are not intended to be exhaustive, but rather are representative. For instance, the computer 100 may include alternate memory storage devices such as magnetic cassettes, digital versatile disks (DVDs), Bernoulli cartridges, and the like. These and other variations are intended to be within the scope of the present invention.

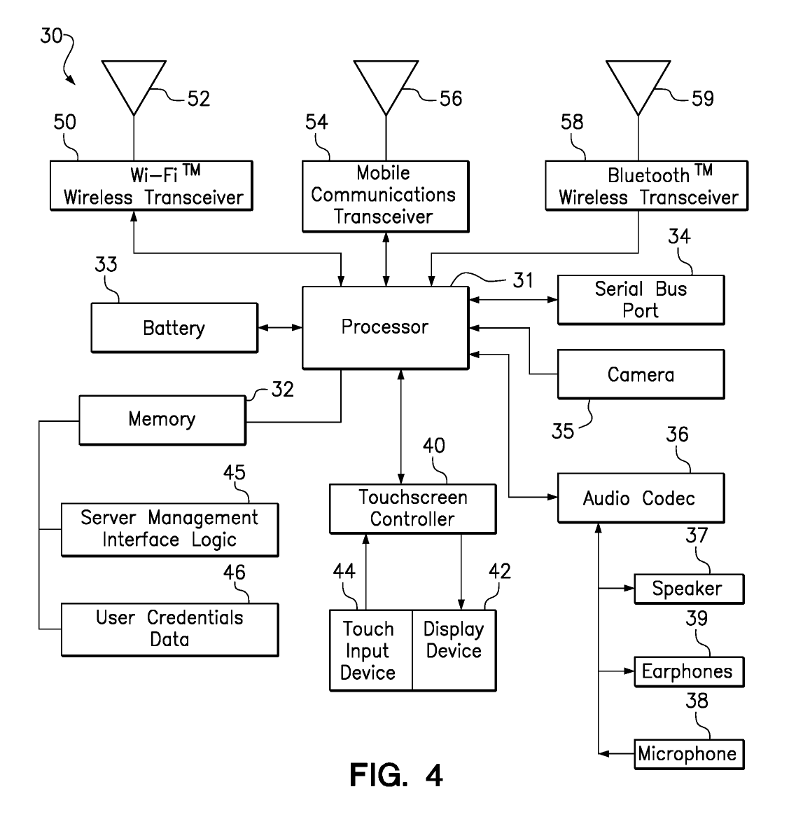

FIG. 4 is a diagram of a mobile computing device in the form of a smartphone 30 capable of implementing various disclosed embodiments. The smartphone 30 may include a processor 31, memory 32, a battery 33, a serial bus port 34 (such as a USB port), a camera 35, and an audio codec 36 coupled to a built-in speaker 37, a microphone 38, and an earphone jack 39. The smartphone 10 may further include a touchscreen controller 40 which provides a graphical output to the display device 42 and an input from a touch input device 44. Collectively, the display device 42 and touch input device 44 may be referred to as a touchscreen. The touchscreen may be in either a locked condition or an unlocked condition. The touchscreen is fully functional in the unlocked condition, but, when the touchscreen is in the locked condition, the touch input device 44 will ignore all attempted input other than a specific unlocking gesture.

The smartphone 30 may also include a Wi-Fi™ wireless transceiver 50 and corresponding antenna 52, a cellular communications transceiver 54 and corresponding antenna 56, and a Bluetooth™ wireless transceiver 58 and corresponding antenna 59. Accordingly, the Bluetooth™ wireless transceiver 58 may, for example, enable communication between the smartphone 30 and the mobile communication device 18 (See FIG. 1). Similarly, the cellular communications transceiver 54 may be used to enable communication between the smartphone 30 and other communication devices 12, and the Wi-Fi™ wireless transceiver 50 may be used to enable communication with the web server 14.

In order to implement one or more embodiments, the memory 32 may include server management interface logic 45 and user credentials data 46. For example, the server management interface logic 45 may be used to send management instructions to the baseboard management controller of a server via the serial bus port 34. The user credentials data 46 may store the user's credentials to avoid repeated re-entry and facilitate authentication with the management computer and any server to which the mobile computing device 30 is connected.

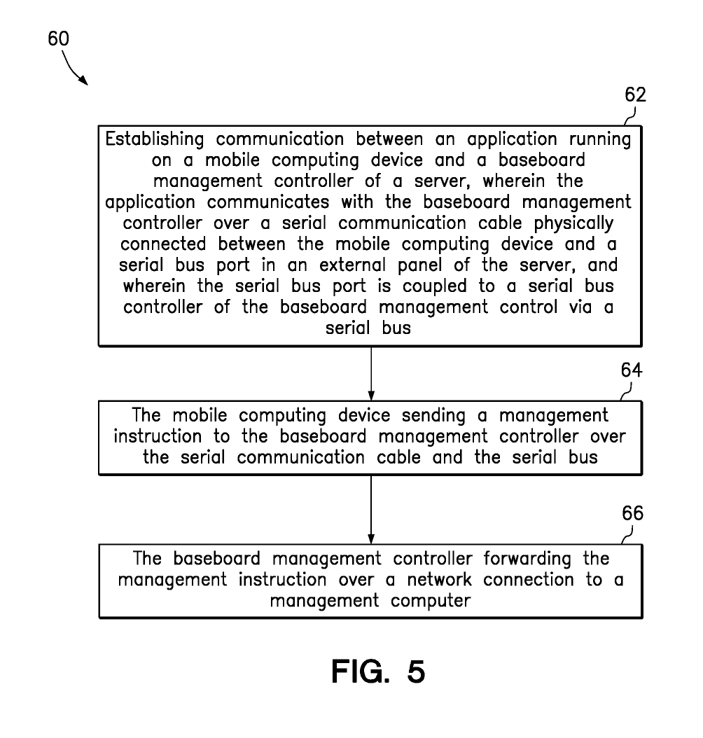

FIG. 5 is a flowchart of a method 60 according to one embodiment. Step 62 includes establishing communication between an application running on a mobile computing device and a baseboard management controller of a server, wherein the application communicates with the baseboard management controller over a serial communication cable physically connected between the mobile computing device and a serial bus port in a front panel of the server, and wherein the serial bus port is coupled to a serial bus controller of the baseboard management controller via a serial bus. Step 64 includes the mobile computing device sending a management instruction to the baseboard management controller over the serial communication cable and the serial bus. Step 66 includes the baseboard management controller forwarding the management instruction over a network connection to a management computer.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
a computer server including a baseboard management controller, wherein the baseboard management controller has a serial bus controller;
a serial bus port disposed along a front panel of a server enclosure that houses the computer server, wherein the serial bus port is accessible for connection with a connector of a serial communication cable; and
a serial bus that couples the serial bus port to the serial bus controller.

2. The apparatus of claim 1, wherein the serial bus port is a Universal Serial Bus port.

3. The apparatus of claim 1, further comprising:
a management computer in communication with the baseboard management controller over a management network.

4. A method, comprising:
establishing communication between an application running on a mobile computing device and a baseboard management controller of a server, wherein the application communicates with the baseboard management controller over a serial communication cable physically connected between the mobile computing device and a serial bus port in a front panel of the server, and wherein the serial bus port is coupled to a serial bus controller of the baseboard management controller via a serial bus;
the mobile computing device sending a management instruction to the baseboard management controller over the serial communication cable and the serial bus; and
the baseboard management controller forwarding the management instruction over a network connection to a management computer.

5. The method of claim 4, wherein the mobile computing device is selected from the group consisting of a smart phone, tablet computer and notebook computer.

6. The method of claim 4, wherein the serial communication port is a universal serial bus port.

7. The method of claim 4, further comprising:
the application providing a management interface for taking various management actions relative to the server to which the mobile computing device is connected.

8. The method of claim 4, further comprising:
the application receiving input of user credentials from a user; and
the application passing the user credential to the management computer to authenticate the user of the application.

9. The method of claim 4, further comprising:
the application obtaining and displaying management data associated with the server, wherein the application displays the management data on a display component of the mobile computing device.

10. The method of claim 4, further comprising:
the application passing information to the server, wherein the information is selected from the group consisting of the location of a rack in which the server is located, the position of the server within the rack, the name of the server, and an Internet Protocol address for the server.

11. The method of claim 10, further comprising:
the server providing the information to the management computer; and
the management computer using the information to generate a virtual rack layout.

12. The method of claim 4, further comprising:
the management computer performing a management task for the server in response to receiving the management instruction.

13. The method of claim 12, wherein the management computer performs the management task for the server after the mobile computing device has been disconnected from the serial communication port.

14. The method of claim 12, further comprising:
the server sending a request for the management computer to initiate performance of the management task for the server, wherein the management computer performs the management task for the server in response to receiving the request.

15. The method of claim 12, further comprising:
the management computer periodically polling the server for a pending management instruction, wherein the server sends the management instruction to the management computer in response to being polled by the management computer.

16. The method of claim 12, wherein the management instruction is a provisioning instruction identifying software to be downloaded from the management computer to the server.

17. The method of claim 12, wherein the management instruction is a provisioning instruction identifying a server profile, wherein the management task includes configuring the server according to a predetermined configuration associated with the identified server profile.
